(19) United States
(12) Patent Application Publication
(10) Pub. No.: US 2009/0231332 A1
(43) Pub. Date: Sep. 17, 2009

(54) PROCESSING 3D GRAPHICS SUPPORTING FIXED PIPELINE

(75) Inventors: Hyun Jae Woo, Gyeonggi-Do (KR); Jeong Ae Park, Seoul (KR); Jeong Ho Woo, Daegu (KR)

Correspondence Address: FISH & RICHARDSON, PC, P.O. BOX 1022, MINNEAPOLIS, MN, 55440-1022, US

(73) Assignees: Core Logic, Inc., Seoul (KR); Korea Advanced Institute of Science and Technology, Daejeon (KR)

(21) Appl. No.: 12/402,424

(22) Filed: Mar. 11, 2009

(30) Foreign Application Priority Data
Mar. 11, 2008 (KR) 10-2008-0022611

(51) Int. Cl. G06T 1/20; G06T 15/00

(52) U.S. Cl. 345/419; 345/506

(57) ABSTRACT

Techniques, apparatus and system for processing 3D graphics are provided. A graphics processor includes a fixed pipeline code generator to convert an application programming interface (API) supporting a fixed pipeline into first microcodes, a shader pipeline code generator to convert an API supporting a programmable pipeline into second microcodes, and a shader pipeline to process the first or second microcodes by using a shader program.

### CLAIM OF PRIORITY

This application claims the benefit of priority of Korean Patent Application No. 2008-0022611 filed on Mar. 11, 2008 with the Korean Intellectual Property Office, the contents of which is incorporated by reference in its entirety herein.

### BACKGROUND

The present disclosure relates to processing 3-dimensional (3D) graphics.

Various three-dimensional (3D) graphics applications are available for execution on mobile environments such as mobile phones, personal digital assistants (PDAs) and portable game consoles. To process the 3D applications, 3D graphics Application Programming Interfaces (APIs) designed for the mobile environments are available. Some of the 3D graphics APIs support a fixed pipeline and others support a programmable pipeline.

### SUMMARY

Techniques, apparatus and systems are described for processing 3D graphics. In particular, the 3D graphics processing techniques, apparatus and systems support both a programmable pipeline and a fixed pipeline.

In an aspect, a graphics processor for processing 3D graphics is provided. The graphics processor includes a fixed pipeline code generator to convert an application programming interface (API) supporting a fixed pipeline into first microcodes, and a shader pipeline code generator to convert an API supporting a programmable pipeline into second microcodes. The graphics processor includes a shader pipeline in communication with the fixed pipeline code generator and the shader pipeline code generator to process at least one of the first and second microcodes by using a shader program.

Implementations can optionally include one or more of the following features. The processor may further include an API selector in communication with the fixed pipeline code generator and the shader pipeline code generator to receive an input API and determine whether or not the received input API supports the fixed pipeline or the programmable pipeline.

In addition, the shader pipeline may comprise a vertex shader and a fragment shader. The fixed pipeline code generator may comprise a state unit to parse an attribute of an object of the received input API and output state information based on the attribute. The fixed pipeline code generator may comprise a code generator to generate the first microcodes based on the state information, and a code buffer to store the generated first microcodes.

The processor may further include a hazard controller to check a processing order and an execution time of at least one of the first and second microcodes in order to identify an occurrence of a hazard indicating a stall and perform a processing in response to the hazard. The hazard controller may comprise a hazard checker to check the processing order and the execution time of each microcode to check whether or not a hazard has occurred, and a reordering unit to reorder the processing order of a hazard-generated microcode. The hazard controller may further comprise a forwarding unit to forward a result value of a preceding microcode of the hazard-generated microcode for an execution of any other microcode.

The API supporting the fixed pipeline may be OpenGL ES 1.x, and the API supporting the programmable pipeline may be OpenGL ES 2.x.

In another aspect, a method performed by a graphics processor for processing 3D graphics is provided. The method includes converting an application programming interface (API) supporting a fixed pipeline into first microcodes recognizable by a shader supporting a programmable pipeline, and processing the microcodes to process 3D graphics. The processed 3D graphics can be stored on a memory, such as a buffer. Also, the processed 3D graphics can be displayed on a display unit of a mobile environment.

Implementation of the method can optionally include one or more of the following features. The method may further include converting an API supporting the programmable pipeline into microcodes recognizable by the shader.

Converting the API supporting fixed pipeline and the API supporting programmable pipeline into the first and second microcodes may comprise acquiring state information based on an attribute of an object of an input API, and generating at least one of the first and second microcodes based on the state information.

Converting the API supporting fixed pipeline and the API supporting programmable pipeline into the first and second microcodes may further comprise checking whether or not a hazard has occurred to stall the execution of a subsequent microcode. Converting the API supporting fixed pipeline and the API supporting programmable pipeline into the first and second microcodes may further comprise when determined that a hazard has occurred, reordering the hazard-generated microcode. Converting the API supporting fixed pipeline and the API supporting programmable pipeline into the first and second microcodes may further comprise when determined that a hazard has occurred, forwarding a result value of a preceding microcode of the hazard-generated microcode to a different microcode.

In still another aspect, a computing device includes a central processing unit (CPU), and a graphics processor coupled with the CPU to process 3D graphics. The graphics processor comprises a fixed pipeline code generator to convert an API supporting a fixed pipeline into first microcodes, a shader pipeline code generator to convert an API supporting a programmable pipeline into second microcodes, and a shader pipeline in communication with the fixed pipeline code generator and the shader pipeline code generator to receive at least one of the first and second microcodes and process a shader program.

Implementations of the computing device can optionally include one or more of the following features. The graphics processor can comprise an API selector in communication with the fixed pipeline code generator and the shader pipeline code generator to receive an input API and determine whether or not the received input API supports the fixed pipeline or the programmable pipeline. The shader pipeline can comprise a vertex shader and a fragment shader. The fixed pipeline code generator can comprise a state unit to parse an attribute of an object of the input API and output state information based on the parsed attribute. The shader pipeline can include code generator to generate the first microcodes based on the output state information. Also, the shader pipeline can include a code buffer to store the first microcodes. The graphics processor can further comprise a hazard controller in communication with the fixed pipeline code generator and the shader pipeline code generator to check a processing order and an execution time of at least one of the first and second microcodes in order to find an occurrence of a hazard indicating a stall and perform a processing in response to the hazard. Further, the hazard controller can comprise a hazard checker to check the processing order and the execution time of each microcode to check whether or not the hazard has occurred; and a reordering unit to reorder the processing order of the hazard-generated microcode.

Implementations of the technique, apparatus and systems can potentially provide one or more of the following advantages. The proposed graphic processing apparatus, systems and methods can provide reduced hardware size and power consumption. An additional command or compiling is not required for the programmable pipeline or the fixed pipeline, and a required memory can be minimized. In addition, a stall of a shader caused by a hazard can be restrained to thus improve the performance of 3D graphics.

### BRIEF DESCRIPTION OF THE DRAWINGS

FIG. 1 illustrates s structure of a programmable pipeline using a shader.

FIG. 2 is an example schematic block diagram of a computing device implementing 3-D graphics processing.

FIG. 3 is an example schematic block diagram of a graphics processor for processing 3-D graphics.

FIG. 4 is an example schematic block diagram of a fixed pipeline code generator.

FIG. 5 illustrates examples of states according to attributes.

FIG. 6 illustrates a format of a 64-bit microcode for an ordinary operation.

FIG. 7 illustrates a format of a 64-bit microcode for a flow control.

FIG. 8 illustrates exemplary generation of microcodes in a fog state.

FIG. 9 illustrates a case where a hazard occurs.

FIG. 10 is a schematic block diagram showing a controller and a code buffer of a fixed pipeline code generator.

FIG. 11 is a flow chart illustrating a graphic processing method.

### DETAILED DESCRIPTION

OpenGL ES (OpenGL for Embedded Systems) is a subset of the OpenGL 3D graphics Application Programming Interface (API) designed for embedded devices such as mobile phones, personal digital assistants (PDAs), and consoles. OpenGL ES is managed by the not-for-profit technology consortium, the Khronos Group, Inc.

Several versions of the OpenGL ES specification are available. For example, OpenGL ES 1.0 is drawn up against the OpenGL 1.3 specification, OpenGL ES 1.1 is described relative to the OpenGL 1.5 specification and OpenGL ES 2.0 is described relative to the OpenGL 2.0 specification. OpenGL ES 2.0, publicly released in March 2007, eliminates most of the fixed-function rendering pipeline in favor of a programmable one. Almost all rendering features of the transform and lighting pipelines, such as the specification of materials and light parameters formerly specified by the fixed-function API, are replaced by shaders written by the graphics programmer.

OpenGL ES 1.x includes at least one version of OpenGL ES 1.0, 1.1, 1.5. OpenGL ES 2.x includes at least one version of OpenGL ES 2.0.

OpenGL ES 1.x is designed for fixed function hardware and offers acceleration, image quality and performance. Also, OpenGL ES 1.x emphasizes hardware acceleration of the API. In contrast to OpenGL ES 1.x, OpenGL ES 2.x enables fully programmable 3D graphics. Also, OpenGL ES 2.x emphasizes a programmable 3D graphics pipeline with the ability to create shader and program objects and the ability to write vertex and fragment shader. OpenGL ES 2.x does not support the fixed function transformation and fragment pipeline of OpenGL ES 1.x. Thus, OpenGL ES 2.x is not backwards compatible with OpenGL ES 1.x.

As described above, OpenGL ES 1.x supports a fixed pipeline while OpenGL ES 2.x supports a programmable pipeline. The programmable pipeline supported by OpenGL ES 2.x uses a shader. A shader is a set of software instructions, which is used primarily to calculate rendering effects on graphics hardware with a high degree of flexibility.

For example, the Direct3D, OpenGL and OpenGL ES graphics libraries use three types of shaders as described below.

(1) A vertex shader is run once for each vertex given to the graphics processor. The purpose is to transform each vertex's 3D position in virtual space to the 2D coordinate at which the 3D position appears on the screen (as well as a depth value for the Z-buffer). The vertex shader can manipulate properties such as position, color, and texture coordinate. The output of the vertex shader is provided to the next stage in the pipeline, which is either a geometry shader when present or otherwise a rasterizer.

(2) A geometry shader can add and remove vertices from a mesh. The geometry shader can be used to generate geometry procedurally or to add volumetric detail to existing meshes that would be too costly to process on a central processing unit (CPU). When the geometry shader is being used, the output is then sent to the rasterizer.

(3) A fragment shader, also known as a pixel shader, can calculate the color of individual fragments (or pixels). The input to this stage comes from the rasterizer, which fills in the polygons being sent through the graphics pipeline. The fragment shader can be typically used for scene lighting and related effects such as bump mapping and color toning. The fixed pipeline provides only a limited form of calculation by adjusting finite state variables to a fixed structure. In comparison, the fragment shader allows general, complicated calculations through programming and can provide theoretically infinite state variables.

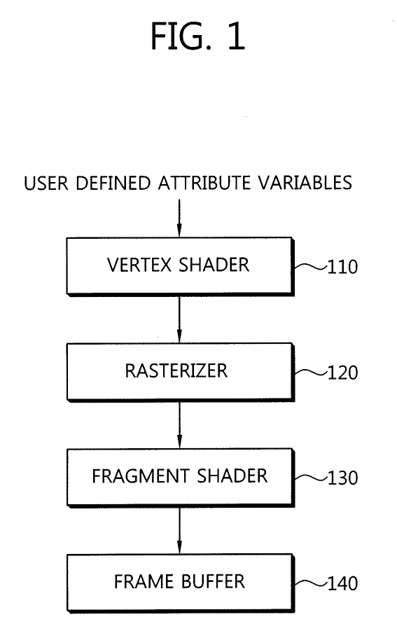

FIG. 1 illustrates a structure of a programmable pipeline using a shader. A vertex shader 110 receives user defined attribute variables and calculates coordinate transformation and/or lighting. An output of the vertex shader 110 is transformed into a raster format by a rasterizer 120. A fragment shader 130 performs processing such as texture calculation (i.e., computation, operation) or color toning. An output of the fragment shader 130 is sent to a frame buffer 140 so as to be processed for a display.

OpenGL ES 2.x is not backward compatible with OpenGL ES 1.x because of the differences between a fixed pipeline and a programmable pipeline. The programmable pipeline can provide flexibility to users, while the fixed pipeline is advantageous in terms of a processing speed.

Not all objects included in a scene of graphics need a shader. Thus, the portion of the scene not requiring splendid, showy graphic effects or the portion requiring rapidity in calculation processing may be expressed based on the OpenGL ES 1.x specification instead of OpenGL ES 2.x. Thus, the techniques, apparatus and systems described in this specification can be used to support both the programmable pipeline and the fixed pipeline. By supporting both programmable and fixed pipelines, the hardware size and power usage can be reduced and made efficient for the particular mobile environment.

Techniques, apparatus and systems described below can be implemented as hardware and/or software for processing diverse 3D graphics APIs (Application Programming Interfaces) such as Direct3D, OpenGL, OpenGL ES, and the like. OpenGL ES 1.x may include at least one version of OpenGL ES 1.0, 1.1, 1.5. OpenGL ES 2.x may include OpenGL ES 2.0.

For illustrative purposes, OpenGL ES 1.x is described in the present specification as a graphics API supporting a fixed pipeline, and OpenGL ES 2.x is described as a graphics API supporting programmable pipeline. The techniques, apparatus and systems described in this specification are applicable to other graphics APIs supporting the fixed pipeline or programmable pipeline.

The contents of following documents are hereby incorporated by reference:
“OpenGL ES 1.1 Specification” which can be obtained as http://www.khronos.org/registry/gles/specs/1.1/es_full_spec.1.1.12.pdf; and
“OpenGL ES 2.0 Specification” which can be obtained as http://www.khronos.org/registry/gles/specs/2.0/es_full_spec_{—}2.0.23.pdf.

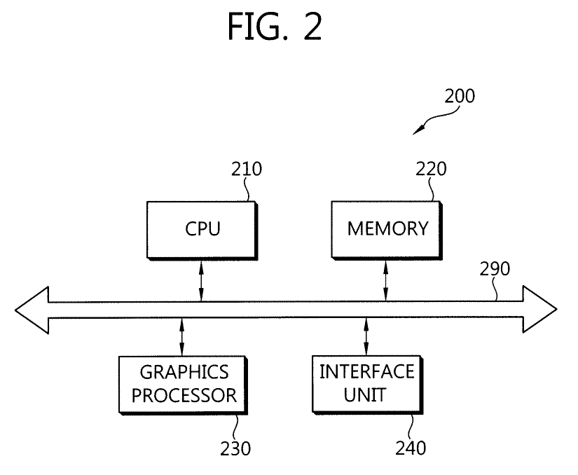

FIG. 2 is an example schematic block diagram of a computing device for implementing 3-D graphics processing. A computing device 200 may be a mobile device such as a mobile phone, a personal digital assistant (PDA), a console, a mobile personal computer, and the like. The computing device 200 includes a central processing unit (CPU) 210, a memory 220, a graphics processor 230, and an interface unit 240. The respective elements of the computer device 200 may be connected via a system bus 290. The CPU 210 can run a software application. The memory 220 stores applications and data used by the CPU 220.

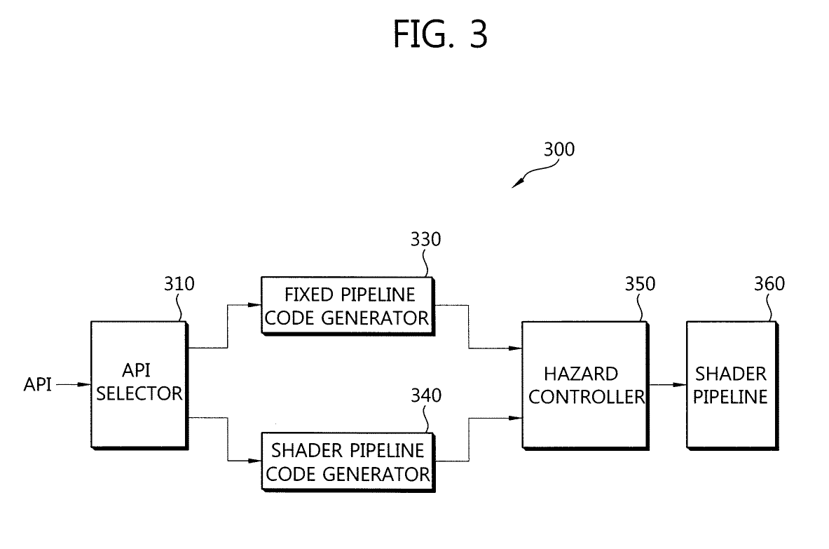

The graphics processor 230 performs 3D graphics processing. The graphics processor 230 may process a graphics API supporting fixed pipeline and/or a graphic API supporting a programmable pipeline. For example, the graphics processor 230 may process the APIs supporting OpenGL ES 1.x and/or OpenGL ES 2.x. Detailed operations for the graphics processor 230 are disclosed hereinafter with respect to FIGS. 3-8.

FIG. 3 is an example schematic block diagram of a graphics processor according to an embodiment of the present specification. A graphics processor 300 includes an API selector 310, a fixed pipeline code generator 330, a shader pipeline code generator 340 and a shader pipeline 360.

The API selector 310 receives an API and determines whether the received API supports a fixed pipeline and/or a programmable pipeline. When determined that the received API supports a fixed pipeline, the API selector 310 sends the fixed pipeline supporting API to the fixed pipeline code generator 330. When determined that the received API supports a programmable pipeline, the API selector 310 sends the programmable pipeline supporting API to the shader pipeline code generator 340.

The fixed pipeline code generator 330 converts the API supporting the fixed pipeline into microcodes (i.e., first microcodes) that can be recognized by the shader pipeline 360. The converted first microcodes identify an operation for the shader pipeline 360 to perform. For example, the fixed pipeline code generator 330 may convert the API based on OpenGL ES 1.x into shade-based microcodes.

The shader pipeline code generator 340 converts the API supporting the programmable pipeline into other microcodes (i.e., second microcodes) that can be recognized by the shader pipeline 360. The converted second pipeline microcodes identify another operation for the shader pipeline 360 to perform. For example, the shader pipeline code generator 340 may convert the API based on OpenGL ES 2.x into shader-based microcodes.

The hazard controller 350 checks for a hazard that may result in a stall when the first microcodes generated by the fixed pipeline code generator 330 and/or the second microcodes generated by the shader pipeline code generator 340 are executed in the shader pipeline 360. When a hazard occurs, the hazard controller 350 performs processing to restrain a stall. Namely, with such hazard generated, the hazard controller 350 may reorder, forward and/or interlock the first and second microcodes.

The shader pipeline 360 processes a shader program through a process of fetching, decoding, and executing the first and second microcode. The shader pipeline 360 may include the vertex shader and the fragment shader as shown in FIG. 1. The vertex shader receives respective vertexes and constants needed for calculating the vertexes, calculates coordinate transformation and lighting, and outputs transformed values. The transformed values may undergo a clipping and rasterization process, which are then inputted to the fragment shader. The fragment shader processes a texture operation and color toning.

The OpenGL ES 2.x supporting a programmable pipeline basically uses the shader program. Thus, the shader pipeline code generator 340 can generate the second microcodes for the shader pipeline 360.

Generating shader-based microcodes from the OpenGL ES 1.x supporting the fixed pipeline is not simple. Compiling could be performed in real time whenever the attribute of an object changes to support the OpenGL ES 1.x. This, however, would call for an additional code memory for hardware. When only a single code memory is chosen to be used, overhead would be generated to delete commands of a previous code memory and insert newly compiled commands whenever a conversion from OpenGL ES 2.x to OpenGL ES 1.x and/or from OpenGL ES 1.x to OpenGL ES 2.x takes place.

The additional code memory or the increase in overhead in the mobile environment would accompany an increase in the hardware size and additional power consumption. Thus, the graphics processor 300 should be designed to have small hardware, low power consumption and high performance.

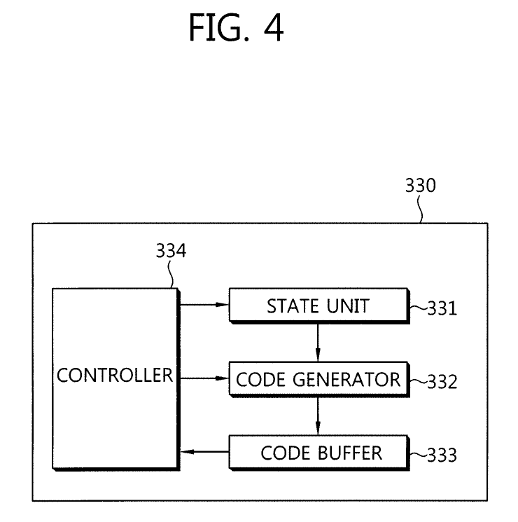

FIG. 4 is an example schematic block diagram of a fixed pipeline code generator according to an embodiment of the present specification. A fixed pipeline code generating unit 330 includes a state unit 331, a code generator 332, a code buffer 333 and a controller 334.

The state unit 331 parses an attribute of an input object, and outputs state information according to the parsed attribute. The state unit 331 changes a state based on a user defined attribute with a finite state machine. Each state may include multiple sub-states.

The code generator 332 generates microcodes based on the state information. Each state is input to a microcode multiplexer (not shown), from which at least one microcode is selectively outputted. A single microcode may have 64 bits.

The code buffer 333 stores the code generator 332 generated microcodes, and sends the stored microcodes to the shader based on an instruction from the controller 334.

The controller 334 manages the state unit 331, the code generator 332 and the code buffer 333. The controller 334 may control changing or holding of the state of the state unit 331 based on the attribute of the object.

The fixed pipeline code generator 330 as described in this specification may have a size of merely 5% of a conventional code memory. Thus, the size of hardware and power consumption can be reduced.

The operation of the fixed pipeline code generator 330 will now be described in more detail through a substantial example.

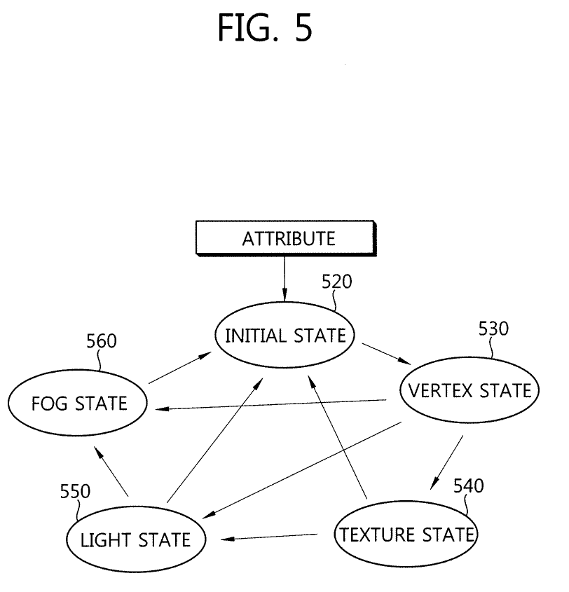

FIG. 5 illustrates examples of attribute based states. Based on an input attribute, a current state is changed to at least one of an initial state, a vertex state, a texture state, a light state and a fog state. Each state may include fifty (50) to one hundred and seventy (170) sub-states.

For example, a fog state in OpenGL ES 1.1 specification is considered. When enabled, the fog state blends a fog color with a rasterized fragment's post-texturing color using a blending factor f. This factor, f, is computed according to one of three equations:

$$\begin{matrix}f = exp ( - d \cdot c ) & ( 1 ) \\ f = exp ( - {( d \cdot c )}^{2} ) & ( 2 ) \\ f = \frac{e - c}{e - s} & ( 3 )\end{matrix}$$

where c is the eye-coordinate distance from the eye, (0; 0; 0; 1) in eye coordinates, to the fragment center. The equation, along with either d or e and s, is specified with
void Fog{xf}(enum pname, T param);
void Fog{xf}(enum pname, T params);

If pname is FOG MODE, then param and/or params should point to an integer that is one of the symbolic constants EXP, EXP2, or LINEAR, in which case equation (1), (2), (3), respectively, is selected for the fog calculation. When pname is FOG DENSITY, FOG START, and/or FOG END, then param and/or params points to a value that is d, s, or e, respectively.

Thus, the fog modes EXP, EXP2, and LINEAR represented by above Equations (1), (2), and (3) indicate how dense the fog is rendered. EXP, EXP2, and LINEAR are sub-states of the fog state. Namely, when the fog mode is enabled and a fog API is provided as an input, a current state is changed to the fog state (or held at the fog state when already at fog state), and one of EXP, EXP2, and LINEAR is designated as a sub-state of the fog state.

The microcodes recognizable by the shader pipeline 360 may have a 64-bit format. The types of instructions associated with the microcodes may be divided into two types: an ordinary operation and a flow control.

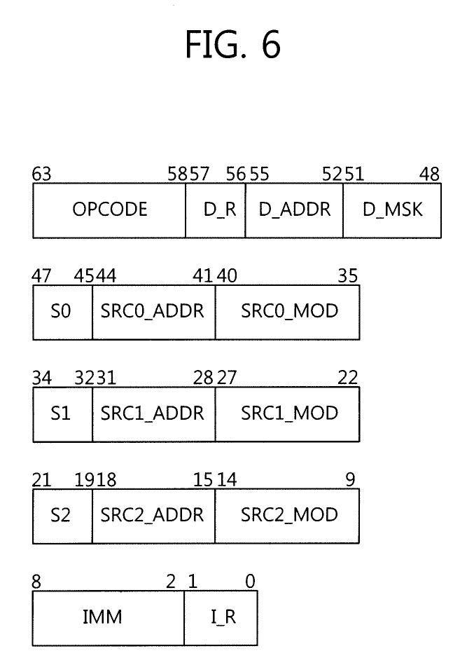

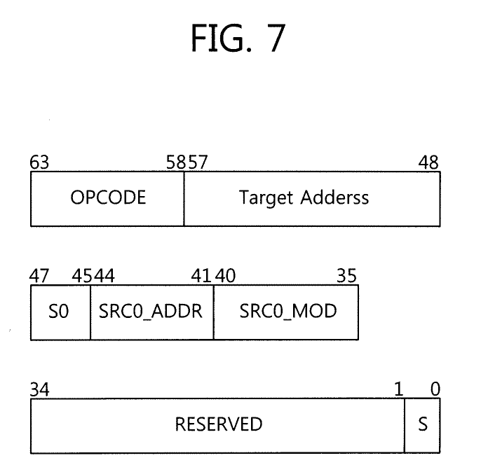

FIG. 6 illustrates an example format of the 64-bit microcodes for the ordinary operation, and FIG. 7 illustrates an example format of the 64-bit microcode for the flow control. Each field is represented as shown in Table 1 below.

TABLE 1

| Field | Length | Description | |
|---|---|---|---|
| OPCODE | 6 | OPCODE | |
| D_R | 2 | Destination Register | |
| | | 00: Output Register | 01: Temporary Register |
| | | 10: Reserved | 11: Texture Register |
| D_ADDR | 4 | Destination Register Address (0~15) | |
| D_MSK | 4 | Destination Register Mask | |
| | | 1xxx: X Field Write Enable | x1xx: Y Field Write Enable |
| | | xx1x: Z Field Write Enable | xxx1: W Field Write Enable |
| S# | 3 | Source # Register | |
| | | 000: Input Register | 001: Temporary Register |
| | | 010: Constant Register | 111: Texture Register |

| | | |
|---|---|---|
| | | 111: No Read |
| SRC# | 4 | Source Register Address (0~15) |
| | | If SRC# is constant or parameter register, this field is used for higher |
| | | 4 bit of immediate. |
| SRC#_MOD | 5 | Source# Modifier |
| | | [5]: Negate Enable (1: Negate, 0: None) |
| | | [4:0]: Swizzing |
| IMM | 7 | Immediate Field (Lower 7bit) |
| I_R | 2 | Instruction Modifier |
| | | 00: None |
| | | 01: x 2 |
| | | 10: /2 |
| | | 11: SAT(out, 0, 1) |
| S | 1 | Option of Flow Control |

Table 2 below shows an example of an instruction set supporting the OpenGL ES shader.

TABLE 2

| OPCODE | SYNTAX | Operation |
|---|---|---|
| MUL | MUL DST SRC1 SRC2 | DST = SRC1 * SRC2 |
| MAD | MAD DST SRC1 SRC2 SRC2 | DST = SRC1*SRC2*SRC3 |
| ADD | ADD DST SRC1 SRC2 | DST = SRC1 + SRC2 |
| SUB | SUB DST SRC1 SRC2 | DST = SRC1 − SRC2 |
| RCP | RCP DST SRC | DST = 1/SRC |
| EXP | EXP DST SRC | DST = 2^{SRC} |
| RSQ | RSQ DSR SRC | DST = 1/SQRT(SRC) |
| MOV | MOV DST SRC | |

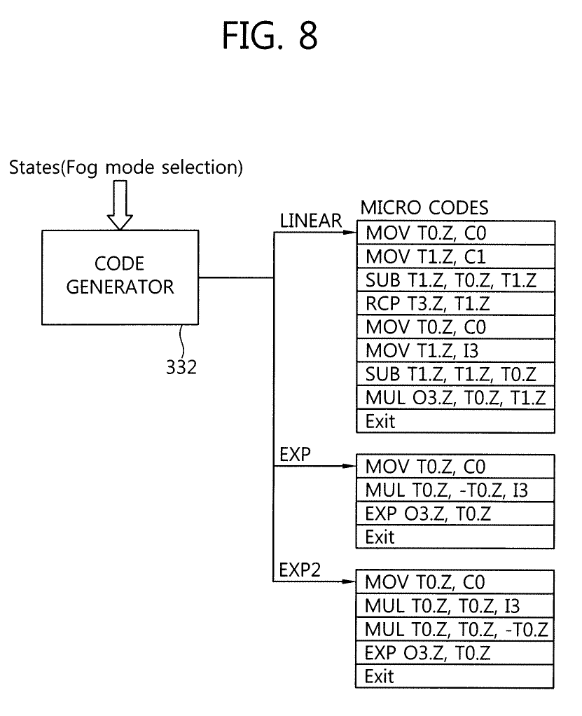

FIG. 8 illustrates exemplary generation of microcodes in the fog state. When the fog mode is selected as a current state, the code generator 332 generates microcodes based on each sub-state. The generated microcodes are input to and processed in the shader.

The microcodes generated according to LINEAR, EXP, and EXP2 are described for illustrative purposes only.

Hazard prevention for allowing the shader pipeline 360 to effectively process the microcodes is described as follows. As the APIs are converted into the microcodes recognizable by the shader, a stall may occur when the shader conducts or processes the microcodes. This occurrence of the stall is called a hazard.

For example, it is assumed that the shader sequentially performs four steps: fetching (F), decoding (D), executing (E), and writing back (W).

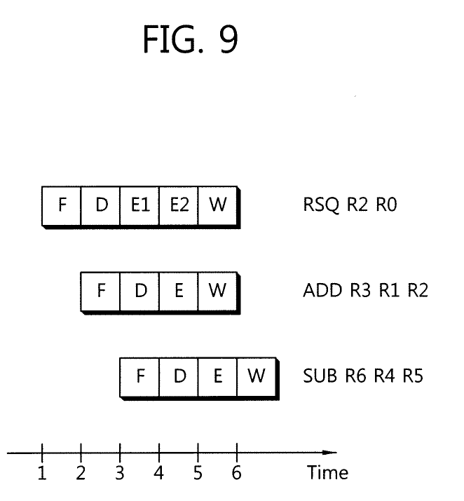

FIG. 9 illustrates an example case where a hazard occurs. Opcode RSQ generally calls for an execution time longer than Opcode ADD or SUB. For example, it is assumed that RSQ requires a total of 5 unit time (F/D/E1/E2/W), and the ADD or SUB requires a total of 4 unit time (F/D/E/W). It is also assumed that the microcodes ‘RSQ R2 R0’, ‘ADD R3 R1 R2’ and ‘SUB R6 R4 R5’ are sequentially carried out at intervals of 1 unit time. In this case, in order to process ‘ADD R3 R1 R2’, ‘RSQ R2 R0’ should be first carried out and completed. However, at a start point of time for ‘ADD R3 R1 R2’, ‘RSQ R2 R0’ has not been completed yet, so the shader defers executing of ‘ADD R3 R1 R2’. This is called interlock. Because conducting of ‘ADD R3 R1 R2’ is deferred, processing of the next microcodes ‘SUB R6 R4 R5’ is also deferred.

Meanwhile, in the above example, ‘SUB R6 R4 R5’ can be processed regardless of whether or not the preceding microcodes ‘RSQ R2 R0’ and ‘ADD R3 R1 R2’ are performed. Thus, changing the processing order of ‘ADD R3 R1 R2’ and ‘SUB R6 R4 R5’ would minimize a stall of the shader and increase the processing speed. This is called reordering.

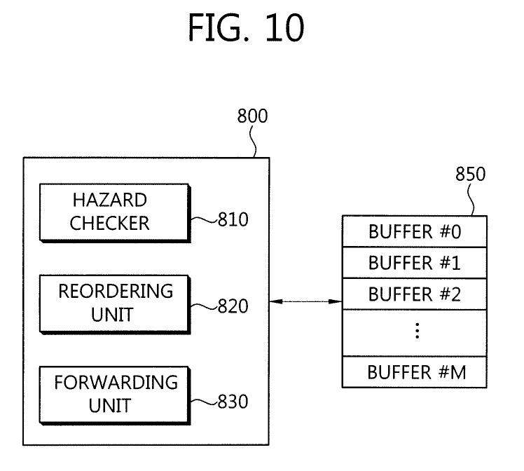

FIG. 10 is an example schematic block diagram of a hazard controller according to an embodiment of the present specification. The hazard controller 800 includes a hazard checker 810, a reordering unit 820, and a forwarding unit 830.

A buffer unit 850 includes multiple buffers including buffer #0, buffer #1, . . . , buffer #M, and each buffer stores microcodes. The buffer unit 850 may be included in the fixed pipeline code generator 330 or in the shader pipeline code generator 340, and may send the microcodes to the hazard controller 800 via the system bus 290. In some implementations, the buffer unit 850 may be included in the hazard controller 800.

The hazard checker 810 checks the processing order and an execution time of each microcode to determine whether or not a hazard has occurred. When determined that a hazard has occurred, the hazard checker 810 checks an execution time and the processing order of a preceding or subsequent microcode of a hazard-generated microcode, and determines whether to perform reordering.

The hazard checker 810 transmits reordering information to the reordering unit 820 so that the reordering unit 820 can reorder the microcodes. In the example of FIG. 9, ‘ADD R3 R1 R2‘and ’ SUB R6 R4 R5’ may be reordered in their processing order to reduce the occurrence of a stall at the shader.

When a result value of the preceding microcode of the hazard-generated microcode is used for executing any other microcode, the forwarding unit 830 forwards the result value to the other microcode.

When a hazard is generated, reordering and/or forwarding are performed to prevent delay that may be caused by a stall, and thus to improve the performance of the shader. Also, data transmission between the graphics processor and the CPU can be reduced to prevent a waste of a bus bandwidth.

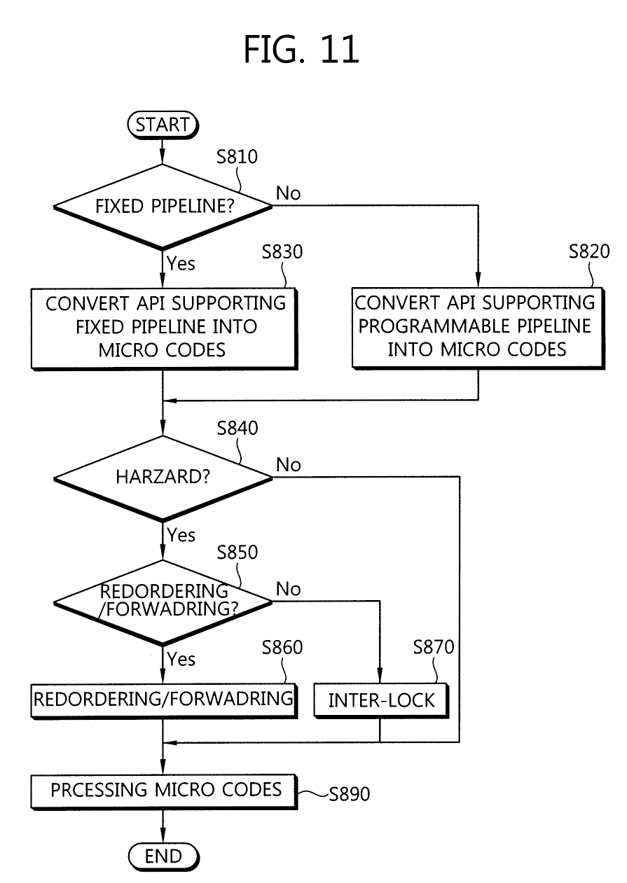

FIG. 11 is an example flow chart illustrating a graphic processing method according to an embodiment of the present specification. In step S810, a graphics processor (e.g., graphics operator 300 that includes the API selector 310) determines whether or not an input API supports the fixed pipeline or the programmable pipeline. For example, is the graphics processor determines whether or not the input API is an API that corresponds to OpenGL ES 1.x and/or an API that corresponds to OpenGL ES 2.x.

In step S820, the graphics processor converts the API supporting the programmable pipeline into first microcodes that can be recognized by the shader.

In step S830, the graphics processor converts the API supporting the fixed pipeline into second microcodes that can be recognized by the shader. In order to convert the APIs into the microcodes, state information that is based on the attributes of the objects of the APIs may be acquired, and the microcodes may be generated based on the state information.

In step S840, the graphics processor checks whether a hazard has occurred to stall the execution of the generated microcodes.

In step S850, when the graphics processor determines that a hazard has occurred, the graphics processor determines whether a stall can be reduced by reordering the hazard-generated microcodes or forwarding previous microcodes. In step S860, the graphics processor reorders and/or forwards the microcodes, or in step S870, the graphics processor interlocks the microcodes.

In step S890, the graphics processor processes the microcodes to process 3D graphics. The processed 3D graphics can be displayed on a display unit of a mobile environment or stored on a storage unit (e.g., buffer or other memory) of the mobile environment.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them.

A computer program (also known as a program, software, software application, script, or code) can be written in any form of programming language, including compiled or interpreted languages, or declarative or procedural languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this specification contains many specifics, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Only a few implementations and examples are described and other implementations, enhancements and variations can be made based on what is described and illustrated in this application.

What is claimed is:

1. A graphics processor for processing 3D graphics, comprising:
a fixed pipeline code generator to convert an application programming interface (API) supporting a fixed pipeline into first microcodes;
a shader pipeline code generator to convert an API supporting a programmable pipeline into second microcodes; and
a shader pipeline in communication with the fixed pipeline code generator and the shader pipeline code generator to process at least one of the first and second microcodes by using a shader program.

2. The graphics processor of claim 1, further comprising:
an API selector in communication with the fixed pipeline code generator and the shader pipeline code generator to receive an input API and determine whether or not the received input API supports the fixed pipeline or the programmable pipeline.

3. The graphics processor of claim 1, wherein the shader pipeline comprises a vertex shader and a fragment shader.

4. The graphics processor of claim 2, wherein the fixed pipeline code generator comprises:
a state unit to parse an attribute of an object of the received input API and output state information based on the parsed attribute;
a code generator to generate the first microcodes based on the output state information; and
a code buffer to store the first microcodes.

5. The graphics processor of claim 1, further comprising:
a hazard controller in communication with the fixed pipeline code generator and the shader pipeline code generator to check a processing order and an execution time of at least one of the first and second microcodes in order to identify an occurrence of a hazard indicating a stall and perform a processing in response to the hazard.

6. The graphics processor of claim 5, wherein the hazard controller comprises:
a hazard checker to check the processing order and the execution time of each microcode to check whether or not the hazard has occurred; and
a reordering unit to reorder the processing order of the hazard-generated microcode.

7. The graphics processor of claim 6, wherein the hazard controller further comprises:
a forwarding unit to forward a result value of a preceding microcode of the hazard-generated microcode for an execution of any other microcode.

8. The graphics processor of claim 1, wherein the API supporting the fixed pipeline comprises OpenGL ES 1.x, and the API supporting the programmable pipeline comprises OpenGL ES 2.x.

9. A method performed by a graphics processor for processing 3D graphics comprising:
converting an application programming interface (API) supporting a fixed pipeline into first microcodes recognizable by a shader supporting a programmable pipeline; and
processing the converted first microcodes to process 3D graphics.

10. The method of claim 9, further comprising:
converting an API supporting the programmable pipeline into second microcodes recognizable by the shader pipeline.

11. The method of claim 10, wherein converting the API supporting the fixed pipeline and the API supporting the programmable pipeline into the first and second microcodes comprises:
acquiring state information based on an attribute of an object of an input API; and
generating the first and second microcodes based on the acquired state information.

12. The method of claim 10, wherein converting the API supporting the fixed pipeline and the API supporting the programmable pipeline into the first and second_microcodes further comprises:
checking each microcode to determine whether or not a hazard has occurred to stall execution of a subsequent microcode.

13. The method of claim 12, wherein converting the API supporting the fixed pipeline and the API supporting the programmable pipeline into the first and second microcodes further comprises:
when determined that the hazard has occurred, reordering the hazard-generated microcode.

14. The method of claim 12, wherein converting the API supporting the fixed pipeline and the API supporting the programmable pipeline into the first and second microcodes further comprises:
when determined that a hazard has occurred, forwarding a result value of a preceding microcode of the hazard-generated microcode to a different microcode.

15. A computing device comprising:
a central processing unit (CPU); and
a graphics processor coupled with the CPU to process 3D graphics, wherein the graphics processor comprises:
a fixed pipeline code generator to convert an API supporting a fixed pipeline into first microcodes;
a shader pipeline code generator to convert an API supporting a programmable pipeline into second microcodes; and
a shader pipeline in communication with the fixed pipeline code generator and the shader pipeline code generator to receive at least one of the first and second microcode and process a shader program.

16. The computing device of claim 15, wherein the graphics processor comprises:
an API selector in communication with the fixed pipeline code generator and the shader pipeline code generator to receive an input API and determine whether or not the received input API supports the fixed pipeline or the programmable pipeline.

17. The computing device of claim 15, wherein the shader pipeline comprises a vertex shader and a fragment shader.

18. The computing device of claim 15, wherein the fixed pipeline code generator comprises:
a state unit to parse an attribute of an object of the input API and output state information based on the parsed attribute;
a code generator to generate the first microcodes based on the output state information; and
a code buffer to store the first microcodes.

19. The computing device of claim 15, wherein the graphics processor further comprises:
a hazard controller in communication with the fixed pipeline code generator and the shader pipeline code generator to check a processing order and an execution time of at least one of the first and second microcodes in order to identify an occurrence of a hazard indicating a stall and perform a processing in response to the hazard.

20. The computing device of claim 19, wherein the hazard controller comprises:
a hazard checker to check the processing order and the execution time of each microcode to check whether or not the hazard has occurred; and
a reordering unit to reorder the processing order of the hazard-generated microcode.
